(19) United States
(12) Patent Application Publication
(10) Pub. No.: US 2019/0087077 A1
(43) Pub. Date: Mar. 21, 2019

(54) INFORMATION PROCESSING APPARATUS, SCREEN CONTROL METHOD

(71) Applicant: KYOCERA Document Solutions Inc., Osaka (JP)

(72) Inventor: Kohei Konishi, Osaka (JP)

(21) Appl. No.: 16/126,757

(22) Filed: Sep. 10, 2018

(30) Foreign Application Priority Data
Sep. 15, 2017 (JP) 2017-177467

(51) Int. Cl. G06F 3/0485; G06T 11/60

(52) U.S. Cl. CPC G06F 3/04855; G06F 2203/04806; G06T 11/60

(57) ABSTRACT

In an information processing apparatus, a first control device displays, on a display device, a still screen in which display items are arranged in a predetermined standard layout. A second control device, when an operation detecting device detects a predetermined scroll operation while the still screen is displayed on the display device, displays, on the display device, a scroll screen including a same number of display items as the still screen in such a manner that the display items move in a scroll direction of the scroll operation while partially replaced with other display items in sequence, and among the display items displayed on the display device, a specific item that is present at a specific position is enlarged compared to the specific item displayed on the still screen.

### INCORPORATION BY REFERENCE

This application is based upon and claims the benefit of priority from the corresponding Japanese Patent Application No. 2017-177467 filed on Sep. 15, 2017, the entire contents of which are incorporated herein by reference.

### BACKGROUND

The present disclosure relates to an information processing apparatus and a screen control method for displaying a scroll screen on a display device.

In general, an information processing apparatus has a function to display a scroll screen on a display device when a scroll operation is detected. The scroll operation is, for example, a swipe operation performed on a touch panel.

In addition, there is known a technology in which, when a scroll speed of the scroll screen changes from a low speed to a high speed, a control portion of a display device enlarges images that are displayed as a list on a display portion, and reduces the number of images displayed on the screen.

### SUMMARY

An information processing apparatus according to an aspect of the present disclosure includes a display device, an operation detecting device, and a control device. The display device is configured to display an image. The operation detecting device is configured to detect an operation of a user. The control device is configured to control the display device. The control device includes a first control device and a second control device. The first control device is configured to display, on the display device, a still screen in which a plurality of display items are arranged in a predetermined standard layout. The second control device is configured to, when the operation detecting device detects a predetermined scroll operation while the still screen is displayed on the display device, display, on the display device, a scroll screen including a same number of display items as the still screen in such a manner that the display items move in a scroll direction of the scroll operation while partially replaced with other display items in sequence, and among the display items displayed on the display device, a specific item that is present at a specific position is enlarged compared to the specific item displayed on the still screen.

A screen control method according to another aspect of the present disclosure includes displaying, on a display device, a still screen in which a plurality of display items are arranged in a predetermined standard layout. Furthermore, the screen control method includes, when an operation detecting device configured to detect an operation of a user detects a predetermined scroll operation while the still screen is displayed on the display device, displaying, on the display device, a scroll screen including a same number of display items as the still screen in such a manner that the display items move in a scroll direction of the scroll operation while partially replaced with other display items in sequence, and among the display items displayed on the display device, a specific item that is present at a specific position is enlarged compared to the specific item displayed on the still screen.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of an information processing apparatus according to an embodiment of the present disclosure.

FIG. 2 is a diagram showing an example of a display panel that is displaying a still screen in the information processing apparatus according to the embodiment.

FIG. 3 is a diagram showing a first example of the display panel that is displaying a scroll screen in the information processing apparatus according to the embodiment.

FIG. 4 is a diagram showing a second example of the display panel that is displaying a scroll screen in the information processing apparatus according to the embodiment.

FIG. 5 is a diagram showing a third example of the display panel that is displaying a scroll screen in the information processing apparatus according to the embodiment.

FIG. 6 is a flowchart showing an example of a procedure of a list image display process executed by the information processing apparatus according to the embodiment.

### DETAILED DESCRIPTION

The following describes an embodiment of the present disclosure with reference to the accompanying drawings. It should be noted that the following embodiment is an example of a specific embodiment of the present disclosure and should not limit the technical scope of the present disclosure.

[Configuration of Information Processing Apparatus 10]

An information processing apparatus 10 according to the present embodiment is an electronic device such as a smartphone, a tablet PC (Personal Computer), or an image forming apparatus.

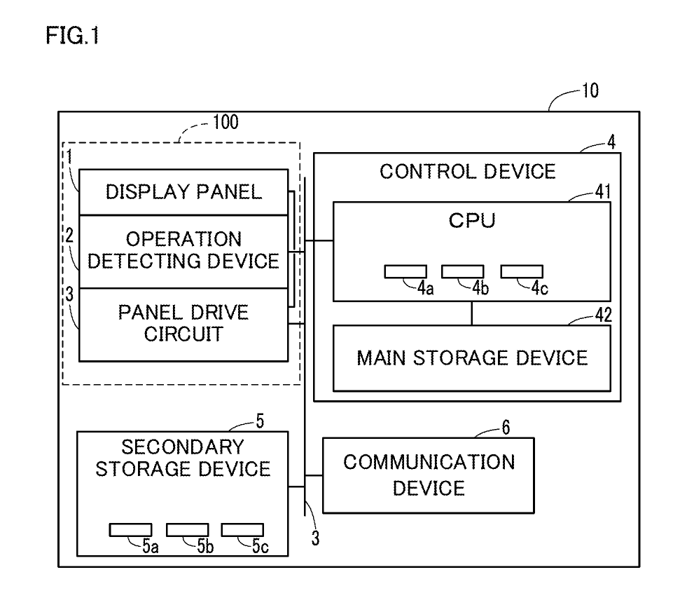

As shown in FIG. 1, the information processing apparatus 10 includes a touch panel 100, a control device 4, a secondary storage device 5, and a communication device 6.

The touch panel 100 includes a display panel 1, an operation detecting device 2, and a panel drive circuit 3. The control device 4 includes a CPU (Central Processing Unit) 41 and a main storage device 42 such as a RAM (Random Access Memory).

The display panel 1 is a panel-like display device such as a liquid crystal panel. The display panel 1 displays images including various types of information in accordance with control by the CPU 41. The display panel 1 is an example of a display device.

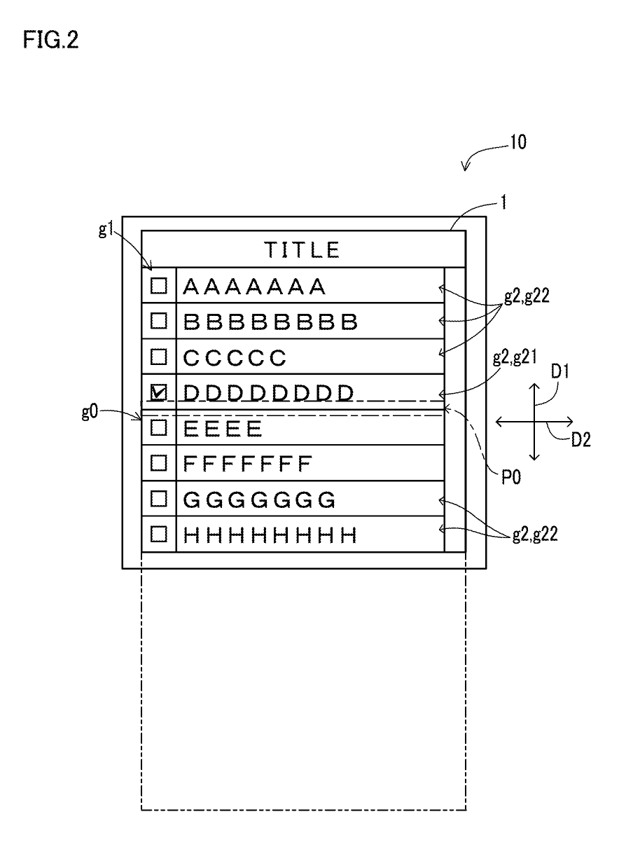

In the following description, one of a longitudinal direction and a width direction of the display panel 1 is referred to as a main direction D1, and the other is referred to as a sub direction D2. In the example shown in FIG. 2, the longitudinal direction is the main direction D1, and the width direction is the sub direction D2.

The operation detecting device 2 detects a user operation performed on the display panel 1. In the present embodiment, the user operation is detected as a touch position or a change of the touch position, the touch position representing a position which was contacted by an operation member that is, for example, a user's finger or a stylus pen.

For example, the operation detecting device 2 may be an electrostatic-capacitance-type, a resistance-type, or an optical-type touch panel. The panel drive circuit 3 is a circuit configured to control a display state of the display panel 1 in accordance with a control signal from the CPU 41.

The communication device 6 is a communication interface device configured to perform communication with another apparatus. For example, the communication device 6 transfers data received from the other apparatus to the CPU 41. In addition, in accordance with a transmission command from the CPU 41, the communication device 6 transmits data transferred from the CPU 41 to the other apparatus.

The CPU 41 performs various types of calculations, data processing, and control of the touch panel 100. For example, the CPU 41 controls the display panel 1 via the panel drive circuit 3.

The main storage device 42 is a computer-readable volatile storage device, such as a RAM (Random Access Memory), configured to temporarily store various programs executed by the CPU 41 and data used in the calculations.

The secondary storage device 5 is a computer-readable non-volatile storage device. For example, a flash memory or a hard disk drive is adopted as the secondary storage device 5. The secondary storage device 5 stores programs executed by the CPU 41, and/or data referenced by the CPU 41.

For example, the CPU 41 functions as an operation determination device 4a by executing an operation determination program 5a that is stored in the secondary storage device 5 in advance.

The operation determination device 4a determines a type of a panel operation performed on the panel, based on a touch position or the like detected by the operation detecting device 2. For example, the operation determination device 4a distinguishes among a scroll operation, an icon specifying operation, and other operations performed on the display panel 1 so as to determine the type of the panel operation. The scroll operation and the icon specifying operation are examples of a predetermined operation.

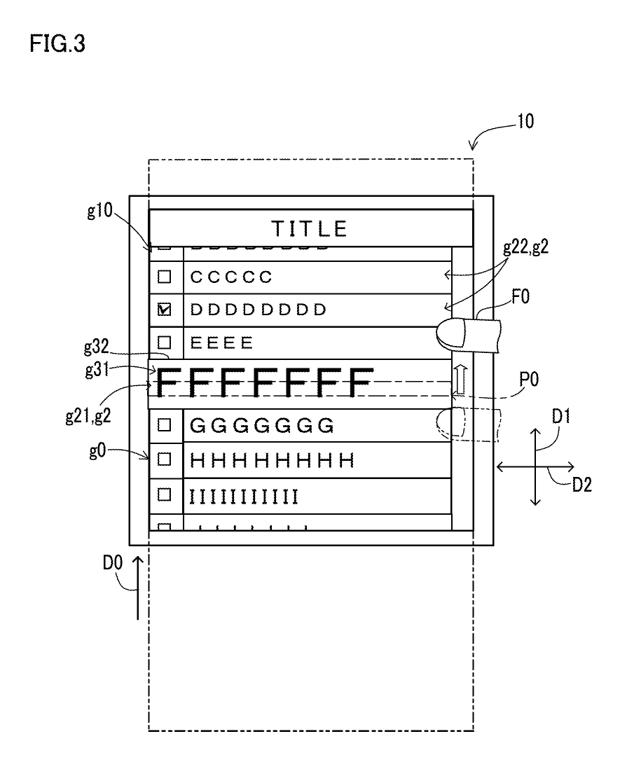

As shown in FIG. 3 to FIG. 5, the scroll operation may be a swipe operation whose touch position changes along the main direction D1. In the example shown in FIG. 3 to FIG. 5, the display panel 1 is operated by a finger F0 of the user. In addition, among two opposite directions included in the main direction D1, a direction toward which the touch position of the swipe operation changes is a scroll direction D0 of the scroll operation.

It is noted that the operation determination device 4a may be realized by a processor such as a DSP (Digital Signal Processor) or a MPU (Micro Processing Unit), or a circuit such as an ASIC (Application Specific Integrated Circuit).

The CPU 41 functions as a first display control device 4b by executing a first display control program 5b that is stored in the secondary storage device 5 in advance. Furthermore, the CPU 41 functions as a second display control device 4c by executing a second display control program 5c that is stored in the secondary storage device 5 in advance.

The first display control device 4b and the second display control device 4c change the display form of the image on the display panel 1 depending on the panel operation determined by the operation determination device 4a. To change the display form, the first display control device 4b and the second display control device 4c control the display panel 1 via the panel drive circuit 3.

In the present embodiment, the first display control device 4b and the second display control device 4c are configured to execute a list image display process of displaying a list image g0 on the display panel 1.

As shown in FIG. 2, a length of the list image g0 along the main direction D1 is larger than a length of the display panel 1 along the main direction D1. On the other hand, a length of the list image g0 along the sub direction D2 is smaller than a length of the display panel 1 along the sub direction D2.

The list image g0 includes a plurality of display items g2. For example, the display items g2 in the list image g0 may be a plurality of contact names, a plurality of addresses, or a plurality of communication addresses.

[List Image Display Process]

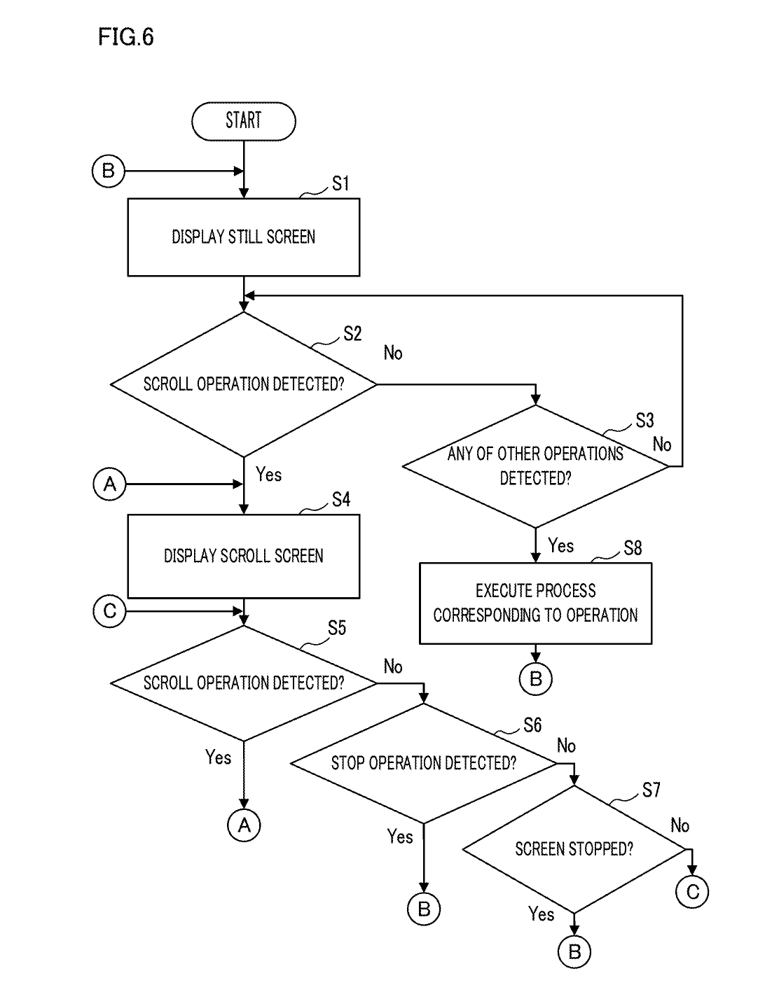

The following describes an example of a procedure of the list image display process with reference to the flowchart shown in FIG. 6.

When the operation determination device 4a determines that a predetermined list display start operation has been detected by the operation detecting device 2, the first display control device 4b starts the list image display process. In the following description, S1, S2, . . . represent identification signs of a plurality of steps included in the list image display process.

<Step S1>

First, the first display control device 4b displays a part of the list image g0 that is too long in the main direction D1 to fit in the display panel 1, on the display panel 1 as a still screen g1 (see FIG. 2).

The first display control device 4b displays, on the display panel 1, the still screen g1 in which the plurality of display items g2 are arranged in a predetermined standard layout (S1). For example, as shown in FIG. 2, in the standard layout, the plurality of display items g2 may be evenly aligned in the main direction D1 without overlapping with each other.

It is noted that in the present embodiment, the control device 4 that is functioning as the first display control device 4b is an example of a first control portion configured to display the still screen g1 on the display panel 1.

<Steps S2, S3>

While the still screen g1 is displayed on the display panel 1, the operation determination device 4a determines whether or not the scroll operation has been detected by the operation detecting device 2 (S2). Furthermore, the operation determination device 4a determines whether or not any of predetermined other operations has been detected (S3).

The above-mentioned other operations include, for example, an operation of touching an icon included in the still screen g1. The operation of touching an icon is performed to request execution of a predetermined process corresponding to the icon.

It is noted that although not shown in FIG. 6, when, in step S3, the operation determination device 4a determines that an operation for requesting ending the list image display process has been detected by the operation detecting device 2, the first display control device 4b ends the list image display process.

<Step S4>

When the operation detecting device 2 detects the scroll operation while the still screen g1 is displayed on the display panel 1, the second display control device 4c displays a scroll screen g10 on the display panel 1 (see FIG. 3 to FIG. 5).

The scroll screen g10 includes a plurality of display items g2 which move in the scroll direction D0 of the scroll operation while partially replaced with other display items in sequence (see FIG. 3 to FIG. 5).

It is noted that in the present embodiment, the CPU 41 functioning as the second display control device 4c is an example of a second control portion configured to display the scroll screen g10 on the display panel 1.

The second display control device 4c displays the scroll screen g10 on the display panel 1 in such a manner that the plurality of display items g2 move at a scroll speed of the scroll operation detected in step S2, then reduces the movement speed of the plurality of display items g2 with a predetermined speed reduction rate.

<Steps S5, S6, S7>

While the scroll screen g10 is displayed on the display panel 1, the operation determination device 4a determines whether or not the scroll operation has been further detected by the operation detecting device 2 (S5).

Upon determining that the scroll operation has been further detected, the operation determination device 4a moves the process to step S4. This allows the second display control device 4c to display the scroll screen g10 in correspondence with the scroll operation detected in step S5.

Furthermore, while the scroll screen g10 is displayed on the display panel 1, the operation determination device 4a determines whether or not a predetermined stop operation has been detected by the operation detecting device 2 (S6). The stop operation is performed to request stopping the scroll of the screen.

For example, the stop operation may be a one-touch operation performed on the display panel 1. Upon determining that the stop operation has been detected, the operation determination device 4a moves the process to step S1. This allows the first display control device 4b to display the still screen g1 that corresponds to the scroll screen g10 that was displayed on the display panel 1 at a time when the stop operation was detected.

In addition, while the scroll screen g10 is displayed on the display panel 1, the second display control device 4c determines whether or not the scroll of the scroll screen g10 was stopped by the speed reduction process in which the scroll speed was reduced with the speed reduction rate.

Upon determining that the scroll of the scroll screen g10 was stopped, the second display control device 4c moves the process to step S1. This allows the first display control device 4b to display the still screen g1 that corresponds to the scroll screen g10 that was displayed on the display panel 1 at a time when the scroll stop was detected.

In a case where the scroll operation or the stop operation has not been detected, and the scroll of the scroll screen g10 has not been stopped, the second display control device 4c continues to display the scroll screen g10 on the display panel 1.

<Step S8>

When the operation determination device 4a determines in step S3 that any of the other operations has been detected, the first display control device 4b executes a process corresponding to the detected operation (S8). Thereafter, the first display control device 4b moves the process to step S1.

For example, when the user performs an operation of touching a check box icon corresponding to one of the plurality of display items g2, the first display control device 4b, in step S8, adds a check mark to the check box icon corresponding to the one of the plurality of display items g2.

As described above, the first display control device 4b and the second display control device 4c display a part of the list image g0 on the display panel 1, and change the display form of the screen displayed on the display panel 1 in response to an operation detected by the operation detecting device 2.

Meanwhile, if the number of the display items g2 changes when the screen displayed on the display panel 1 is switched from the still screen g1 to the scroll screen g10, the discontinuous change of the display screen may give a sense of discomfort to the user. Furthermore, when the number of display items g2 on the screen is reduced, the user may need to increase the number of scroll operations to display an intended item on the display screen.

On the other hand, there is a demand that the visibility of the display items g2 on the scroll screen g10 be improved. Here, enlarging the display items g2 on the scroll screen g10 contributes to improvement of the visibility of the display items g2.

The information processing apparatus 10 is configured to improve the visibility of the display items g2 on the scroll screen g10 while avoiding a discontinuous change of screen when the display screen is switched from the still screen g1 to the scroll screen g10.

That is, in step S4 of FIG. 6, the second display control device 4c displays, for example, the scroll screen g10 shown in FIG. 3 on the display panel 1.

The scroll screen g10 shown in FIG. 3 includes the same number of display items g2 as the still screen g1, and the display items g2 move in the scroll direction D0 while partially replaced with other display items in sequence. With this configuration, a discontinuous change of the screen is avoided when the screen is switched from the still screen g1 to the scroll screen g10.

Furthermore, in the scroll screen g10 shown in FIG. 3, among the plurality of display items g2, a specific item g21 that is present at a specific position P0 is enlarged compared to the specific item g21 displayed on the still screen g1. This improves the visibility of the specific item g21 on the scroll screen g10. It is noted that the specific position P0 is set at the center of the scroll screen g10 in the scroll direction D0.

Furthermore, in the scroll screen g10 shown in FIG. 3, among the plurality of display items g2, non-specific items g22 other than the specific item g21 are reduced in size compared to the non-specific items g22 displayed on the still screen g1.

In the example shown in FIG. 3, the specific item g21 and the non-specific items g22 are displayed on the display panel 1 while not overlapping with each other. With this configuration, even if the specific item g21 is enlarged, the non-specific items g22 can be confirmed, and thus the listing of the plurality of display items g2 is ensured.

For example, the scroll screen g10 may be displayed in such a manner that the plurality of display items g2 move at a scroll speed of the scroll operation, and the size of the specific item g21 changes in correspondence with the scroll speed.

For example, the higher the scroll speed is, the larger the size of the specific item g21 is. With this configuration, it is possible to improve the visibility of the specific item g21 even when the scroll speed is high.

In the present embodiment, the specific item g21 includes a character sequence g31 and a frame g32 that surrounds the character sequence g31. In the example shown in FIG. 3, both the character sequence g31 and the frame g32 of the specific item g21 are enlarged.

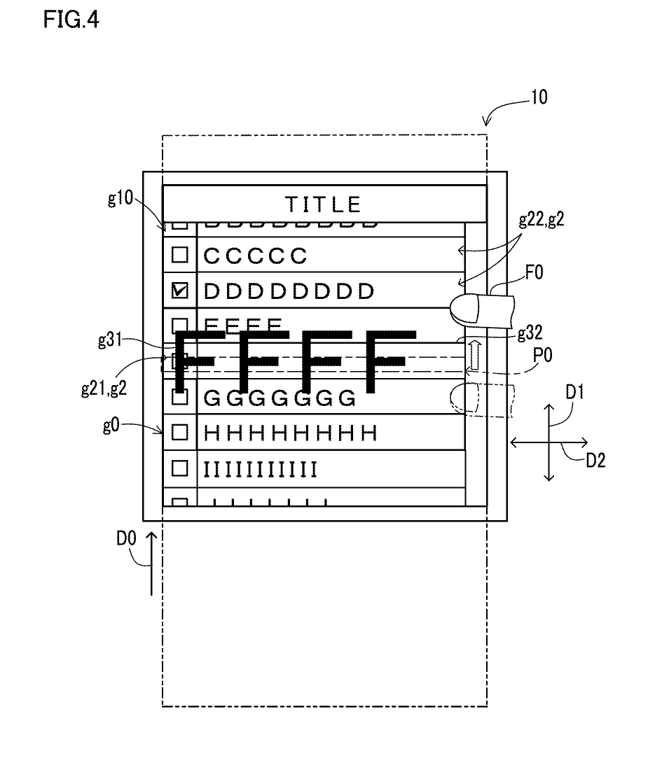

On the other hand, in the scroll screen g10 shown in FIG. 4, the character sequence g31 of the specific item g21 is enlarged compared to that in the still screen g1, but the frame g32 of the specific item g21 is the same as in the still screen g1.

In step S4 of FIG. 6, the second display control device 4c may display the scroll screen g10 shown in FIG. 4, on the display panel 1.

In the scroll screen g10 shown in FIG. 4, the enlarged character sequence g31 of the specific item g21 is displayed in a state of overlapping with the non-specific items g22 that are adjacent to the specific item g21. With this configuration, the scroll screen g10 includes the same number of display items g2 as the still screen g1.

In addition, as shown in FIG. 4, the second display control device 4c may display the scroll screen g10 on the display panel 1 by omitting a part of the enlarged specific item g21.

For example, in a case where a part of the specific item g21 in the enlarged state protrudes from the display area of the display panel 1, the second display control device 4c may display only the other part of the enlarged specific item g21 that remains within the display area.

In the example shown in FIG. 4, the length of the character sequence g31 in the specific item g21 in the sub direction D2 that has been enlarged by an enlargement rate corresponding to the scroll speed, exceeds the length of the display panel 1 in the sub direction D2. As a result, only a part of the enlarged character sequence g31 in the specific item g21 that remains within the length of the display panel 1 in the sub direction D2, is displayed on the display panel 1.

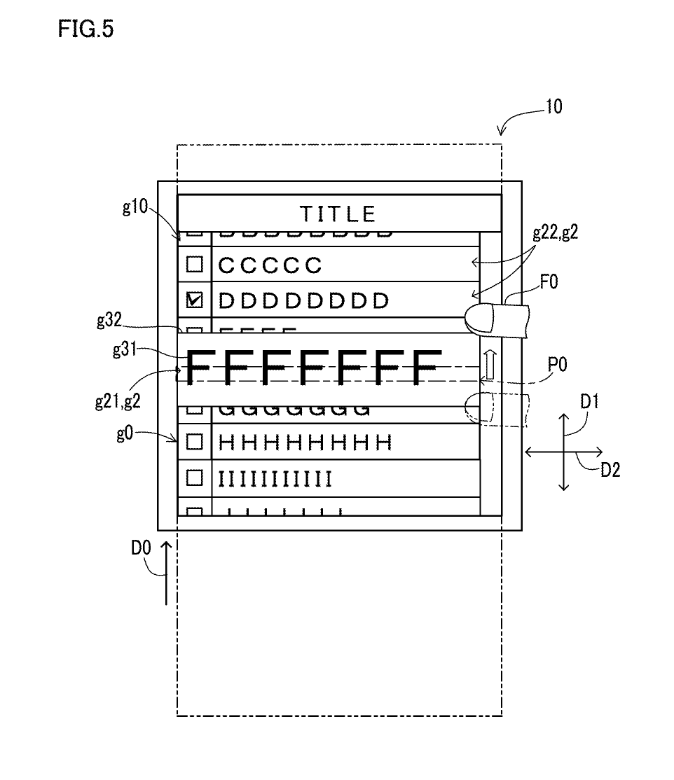

In the scroll screen g10 shown in FIG. 5, too, the enlarged specific item g21 is displayed in a state of overlapping with the non-specific items g22 that are adjacent to the specific item g21. However, in the scroll screen g10 shown in FIG. 5, both the character sequence g31 and the frame g32 of the specific item g21 are enlarged.

The second display control device 4c may display the scroll screen g10 shown in FIG. 5 on the display panel 1.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An information processing apparatus comprising:
a display device configured to display an image;
an operation detecting device configured to detect an operation of a user; and
a control device configured to control the display device, wherein
the control device includes:
a first control device configured to display, on the display device, a still screen in which a plurality of display items are arranged in a predetermined standard layout; and
a second control device configured to, when the operation detecting device detects a predetermined scroll operation while the still screen is displayed on the display device, display, on the display device, a scroll screen including a same number of display items as the still screen in such a manner that the display items move in a scroll direction of the scroll operation while partially replaced with other display items in sequence, and among the display items displayed on the display device, a specific item that is present at a specific position is enlarged compared to the specific item displayed on the still screen.

2. The information processing apparatus according to claim 1, wherein
the second control device is configured to display the specific item in an enlarged state by omitting a part thereof.

3. The information processing apparatus according to claim 2, wherein
in a case where a part of the specific item in the enlarged state protrudes from a display area of the display device, the second display control device displays only another part of the specific item that remains within the display area, on the display device.

4. The information processing apparatus according to claim 1, wherein
the second control device displays the scroll screen on the display device in such a manner that, among the display items displayed on the display device, non-specific items other than the specific item are reduced in size compared to the non-specific items displayed on the still screen.

5. The information processing apparatus according to claim 1, wherein
the second control device displays the scroll screen on the display device in such a manner that, among the display items displayed on the display device, the specific item is displayed in a state of overlapping with adjacent non-specific items.

6. The information processing apparatus according to claim 1, wherein
the second control device displays the scroll screen on the display device in such a manner that the display items move at a scroll speed of the scroll operation, and a size of the specific item changes in correspondence with the scroll speed.

7. A screen control method comprising:
displaying, on a display device, a still screen in which a plurality of display items are arranged in a predetermined standard layout; and
when an operation detecting device configured to detect an operation of a user detects a predetermined scroll operation while the still screen is displayed on the display device, displaying, on the display device, a scroll screen including a same number of display items as the still screen in such a manner that the display items move in a scroll direction of the scroll operation while partially replaced with other display items in sequence, and among the display items displayed on the display device, a specific item that is present at a specific position is enlarged compared to the specific item displayed on the still screen.
